(19) United States
(12) Patent Application Publication
(10) Pub. No.: US 2003/0079184 A1
(43) Pub. Date: Apr. 24, 2003

(54) Dynamic image storage using domain-specific compression

(75) Inventors: Israel Berger, Haifa (IL); Eugene Walach, Haifa (IL); Aviad Zlotnick, Galil Takhton (IL)

Correspondence Address: Stephen C. Kaufman, IBM Corporation, Intellectual Property Law Dept., P.O. Box 218, Yorktown Heights, NY, 10598, US

(73) Assignee: International Business Machines Corporation, Armonk, NY

(21) Appl. No.: 10/323,421

(22) Filed: Dec. 18, 2002

Related U.S. Application Data
(63) Continuation-in-part of application No. 09/566,058, filed on May 5, 2000.

(51) Int. Cl. G06F 15/00

(52) U.S. Cl. 715/515

(57) ABSTRACT

A method for storing images that are input to a storage system by one or more operators. Some of the images are classified into a plurality of predefined groups, such that the images in each predefined group of the plurality are characterized by respective common information shared by all the images in the predefined group. Other images, which were not classifiable into any of the predefined groups, are processed so as to define a new group containing a subset of the second portion of the images, such that the images in the new group are characterized by new common information shared by all the images in the new group. The images in each group among the predefined and new groups are compressed by extracting from each of the images the common information that characterizes the group.

### CROSS-REFERENCE TO RELATED APPLICATIONS

This application is a continuation-in-part of co-pending U.S. patent application Ser. No. 09/566,058, filed May 5, 2000. It is also related to U.S. patent application Ser. No. 09/777,792, filed Feb. 6, 2001, published as U.S. Patent Application Publication 2002/0106128 A1. Both of these related applications are assigned to the assignee of the present patent application and are incorporated herein by reference.

### FIELD OF THE INVENTION

The present invention relates generally to document image processing, and specifically to systems and methods for compressing and storing form images.

### BACKGROUND OF THE INVENTION

Businesses and organizations are increasingly turning to computerized processing and storage of information filled in on documents such as paper forms, in addition to or in place of processing and storing the forms themselves. After the form has been filled out, it is optically scanned and transferred to electronic storage media, such as a magnetic or optical disk. The stored document can subsequently be retrieved for processing by an optical character recognition (OCR) program or by a human operator. A large organization, such as a bank, may store millions of images in this manner. Some companies have begun to offer this sort of document storage as a utility-like service, with the capability of storing huge volumes of data at multiple, linked locations.

In order to ensure that a document is accurately processed, it is necessary to scan the document at high resolution, typically on the order of 100 pixels/cm. To store an entire A4 page in this manner, however, even at only one bit/pixel (i.e., a binary image of the page), requires about 700 Kbytes of memory. Methods of image compression, as are known in the art, are applied to reduce the volume of data that must be recorded and stored in order to reproduce a document.

A significant portion of the data in an image of a filled-in form corresponds to the form template, i.e., the lines, boxes, instructions, etc., that are preprinted on every form of a given type. Since this element of the form is predetermined and fixed, a useful way to reduce the volume of data that must be stored in recording the image of a filled-in form is to first remove the fixed template. Then the “fill image”—what remains of the form after removal of the template—is processed and/or compressed and stored. Only a single image of the template needs to be stored, regardless of how many filled-in instances of a given form are to be stored and reproduced. To view the form as originally filled in, the template and fill images are recalled from memory and recombined.

For example, U.S. Pat. Nos. 5,182,656, 5,191,525, 5,793,887, and 5,631,984, whose disclosures are incorporated herein by reference, describe methods for compressing and decompressing form images based on separation of the form template from the variable fill portion of the form. Methods of automatic form processing known in the art, such as those described in these patents, assume as their point of departure that the form template is known in advance, or at least can be selected by the computer from a collection of templates that are known in advance. In other words, the computer must have on hand the appropriate empty template for every form type that it processes. This information is typically input to the computer by an expert operator before starting up processing operations. In large-scale form-processing applications, however, it frequently happens that not all template or template variations are known, or that unexpected variations occur. Acquiring and maintaining a full set of all possible templates can itself be complicated and costly.

### SUMMARY OF THE INVENTION

Preferred embodiments of the present invention provide methods for enhancing compression efficiency in image storage systems, particularly large-scale, distributed systems. These methods enable such systems to automatically identify and extract common information from groups of images, and then to use the common information in compressing the images in each group. For example, document storage systems may use the methods of the present invention to extract form templates from document images. Typically, no operator involvement is required in this process, even when the image grouping and common information are not known in advance. From the operator's perspective, the system simply accepts and stores images, and then retrieves the images on demand.

The image grouping and compression process runs on the system automatically, in background, in a manner transparent to the operator. In the case of document processing, each input image is compared to a repository of templates. If a matching template is found, the image is compressed using that template, by template drop-out, for example. Images that have not been compressed in this manner (because no matching template was found) are compared with each other in order to identify new image groups and extract templates for these groups. The new templates thus identified are used in compressing the images in the newly-identified groups, and are also added to the repository for subsequent use. In distributed image storage systems, the repository of templates may be shared among multiple servers at different locations. Thus, when an image stored at one location must be retrieved at another location, only the compressed image (without the template) need be transmitted to the retrieval location, thus reducing communication bandwidth requirements, as well as storage volume.

The system may also attempt to find subgroups of similar images among the images that have already been compressed. When such a subgroup is found, the system may extract a more detailed template, to be applied in compressing the images in the subgroup. In this manner, the system may iteratively increase the degree to which stored images are compressed, and thus use its available storage more effectively.

Although the preferred embodiments described herein relate primarily to processing of images of form documents, the principles of the present invention may similarly be applied in extracting information from groups of images of other types, in which the images in a group contain a common, fixed part and an individual, variable part. The use of common information in a defined group of images in compressing the images is referred to herein generally as “domain-specific compression.”

There is therefore provided, in accordance with a preferred embodiment of the present invention, a method for storing images that are input to a storage system by one or more operators, the method including:

classifying a first portion of the images into a plurality of predefined groups, such that the images in each predefined group of the plurality are characterized by respective common information shared by all the images in the predefined group;

processing a second portion of the images, which were not classifiable into any of the predefined groups, so as to define a new group containing a subset of the second portion of the images, such that the images in the new group are characterized by new common information shared by all the images in the new group; and

compressing the images in each group among the predefined and new groups by extracting from each of the images the common information that characterizes the group.

Preferably, the steps of classifying, processing and compressing are carried out autonomously by the storage system, substantially without involvement of the one or more operators.

In a preferred embodiment, the images include images of form documents, and extracting the common information includes removing a template of the form documents from the images.

Optionally, the method includes processing at least one of the predefined and new groups so as to subdivide the at least one of the groups into sub-groups, each characterized by respective sub-group common information, wherein compressing the images includes extracting the respective sub-group common information from the images in the sub-groups. Preferably, the method includes storing the compressed images in a memory of the storage system, wherein processing the at least one of the predefined and new groups includes recalling the compressed images in the at least one of the predefined and new groups from the memory in order to process the images, and wherein the images in the sub-group occupy a reduced volume of the memory after the respective subgroup common information is extracted from the images.

Preferably, processing the second portion of the images includes adding the new group to the plurality of predefined groups for use in classifying further images that are subsequently input to the storage system.

Further preferably, processing the second portion of the images includes collecting the images that are not classifiable into any of the predefined groups, and processing the collected images on a scheduled basis. Additionally or alternatively, processing the second portion of the images includes collecting the images that are not classifiable into any of the predefined groups, and processing the collected images when a predetermined number of the images that are not classifiable have been collected.

There is also provided, in accordance with a preferred embodiment of the present invention, apparatus for storing images that are input by one or more operators, the apparatus including an image processor, which is arranged to classify a first portion of the images into a plurality of predefined groups, such that the images in each predefined group of the plurality are characterized by respective common information shared by all the images in the predefined group, to process a second portion of the images, which were not classifiable into any of the predefined groups, so as to define a new group containing a subset of the second portion of the images, such that the images in the new group are characterized by new common information shared by all the images in the new group, and to compress the images in each group among the predefined and new groups by extracting from each of the images the common information that characterizes the group.

Preferably, the apparatus includes a memory, which is arranged to store the compressed images, wherein the image processor is arranged to recall the compressed images in the at least one of the predefined and new groups from the memory in order to process the images.

In a preferred embodiment, the image processor is one of at least first and second image processors included in the apparatus at respective first an second locations, which are mutually remote and are connected by a communication link, and the first image processor is arranged to convey the new common information to the second image processor over the communication link, and the second image processor is arranged to store the new common information at the second location for use in at least one of compressing and decompressing further images at the second location.

There is additionally provided, in accordance with a preferred embodiment of the present invention, a computer software product for storing images that are input to a storage system by one or more operators, the product including a computer-readable medium in which program instructions are stored, which instructions, when read by a computer, cause the computer to classify a first portion of the images into a plurality of predefined groups, such that the images in each predefined group of the plurality are characterized by respective common information shared by all the images in the predefined group, to process a second portion of the images, which were not classifiable into any of the predefined groups, so as to define a new group containing a subset of the second portion of the images, such that the images in the new group are characterized by new common information shared by all the images in the new group, and to compress the images in each group among the predefined and new groups by extracting from each of the images the common information that characterizes the group.

The present invention will be more fully understood from the following detailed description of the preferred embodiments thereof, taken together with the drawings in which:

### BRIEF DESCRIPTION OF THE DRAWINGS

FIG. 1 is a schematic illustration of a computer system for document image processing, in accordance with a preferred embodiment of the present invention;

FIGS. 2A and 2B are flow charts that schematically illustrate methods for storing and retrieving document images, respectively, in accordance with a preferred embodiment of the present invention;

FIG. 3 is a flow chart that schematically illustrates a method for processing stored document images, in accordance with a preferred embodiment of the present invention; and

FIGS. 4 and 5 are flow charts that schematically illustrate details of the method of FIG. 3, in accordance with preferred embodiments of the present invention.

### DETAILED DESCRIPTION OF PREFERRED EMBODIMENTS

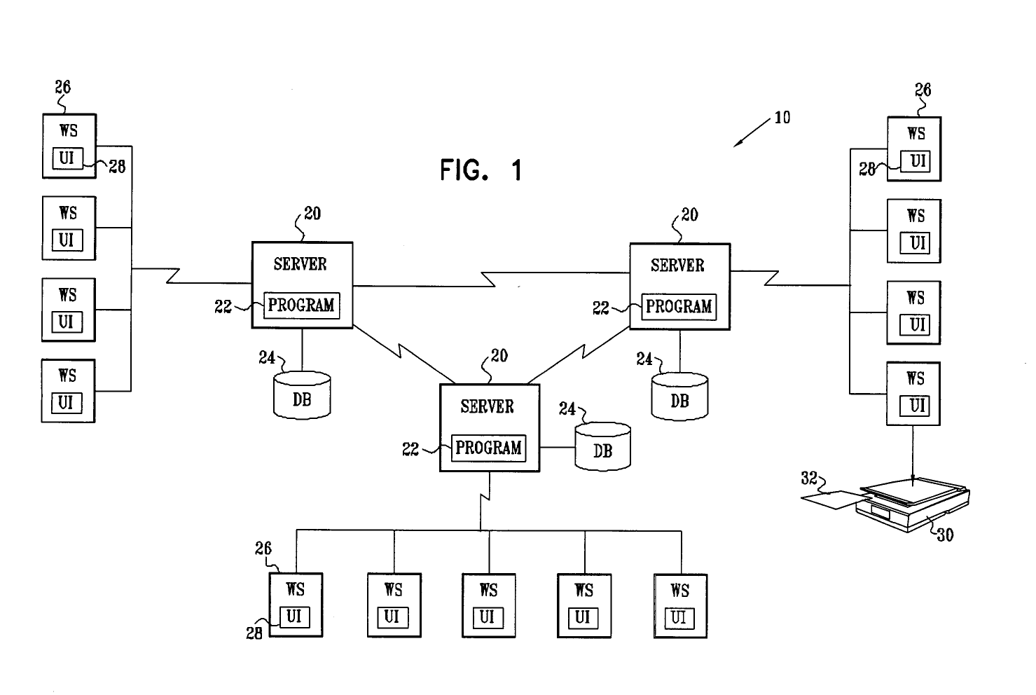

FIG. 1 is a block diagram that schematically illustrates a computer system 10 for processing of form document images, in accordance with a preferred embodiment of the present invention. Computer system 10 comprises a group of servers 20, which are connected to each other using a network of a suitable type, as is known in the art. The servers may be configured as a distributed computing system. Alternatively, the present invention may be carried out using other multi-server configurations, or using a single server, such as a mainframe computer. Computer system 10 further comprises workstations 26, each connected to communicate with one or more of the servers. The workstations convey images to the servers to be stored in an image database 24, typically comprising a storage memory on a magnetic or optical disk, and retrieve images from the database via the servers as required.

Typically, workstations 26 receive images for input to system 10 by means of an input device, such as a scanner 30, or any other suitable type of image capture device known in the art. In the embodiment shown in FIG. 1, scanner 30 is used to scan documents 32, each comprising a preprinted form, which is typically filled in with handwritten, typed or printed characters. Additionally or alternatively, the image is input from another source to the workstation or directly to server 20. Workstation 26 has a user interface 28, which typically comprises user controls and a display, for use in inputting document images to system 10 and retrieving and displaying documents from the system.

Each server 20 comprises an image processor 22, which is typically a general-purpose computer, programmed with software for compressing and decompressing images in database 24, as described in detail hereinbelow. Briefly, processor 22 attempts to register each document image with one of a plurality of reference template images that are stored in database 24. When the processor finds a matching template, it removes the template from the document image, and then stores only the fill image remaining after the template has been dropped out. Any suitable drop-out method may be used for this purpose, such as the methods described in the above-mentioned U.S. Pat. Nos. 5,182,656, 5,191,525, 5,793,887, and 5,631,984. Preferably, the template dropout is carried out in a manner that is designed to minimize any deleterious impact on the readability of characters filled into the template. A drop-out method of this type is described, for example, in U.S. patent application Ser. No. 09/379,244, which is assigned to the assignee of the present patent application, and whose disclosure is incorporated herein by reference.

When no suitable template is found in database 24 for a given document image, processor 22 attempts to generate an appropriate new template, using methods described in detail hereinbelow. For this purpose, the processor first groups the given document image with other, similar document images for which it has not succeeded in finding a template. The processor then processes the images in the group in order to extract a new template. Automated methods for identifying image groups and extracting templates from such groups are described, for example, in the above-mentioned U.S. patent application Ser. Nos. 09/566,058 and 09/777,792. Alternatively, other methods known in the art for imaging grouping and template extraction may be used. The new template thus extracted is used in compressing the images in the new group, and is added to the set of reference templates stored in database 24 for use in compressing other images, as well.

The software run by processor 22 may be supplied to server 20 on tangible media, such as diskettes or CD-ROM, and loaded into the processor. Alternatively, the software may be downloaded to the processor via a network connection or other electronic link. Further alternatively, processor 22 may comprise dedicated, hardwired elements or a digital signal processor for carrying out some or all of the required image processing steps.

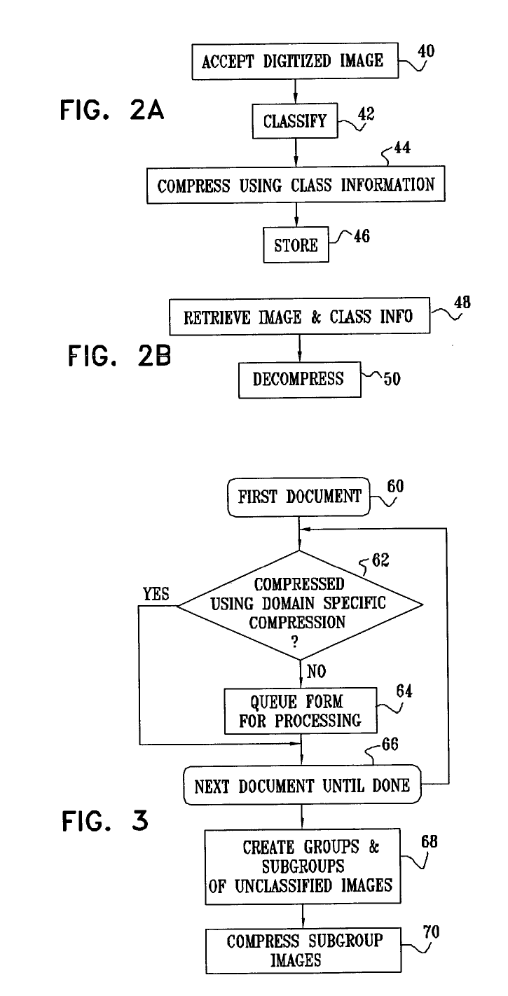

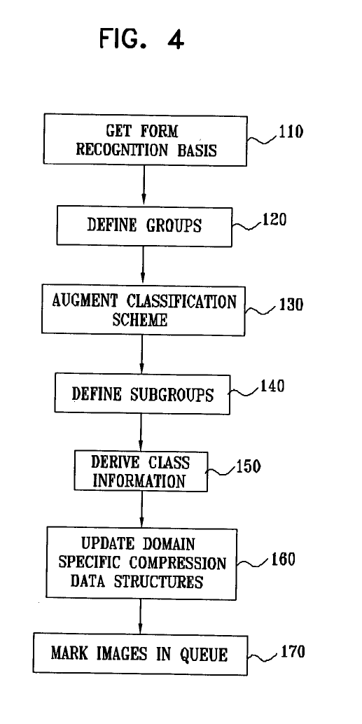

FIG. 2A is a flow chart that schematically illustrates a method for storing of form document images, such as document 32, in accordance with a preferred embodiment of the present invention. At an initial step 40, a digitized image is input to server 20, typically via one or workstations 26. At a form recognition step 42, the image is classified according to its characteristics. Processor 22 attempts to match the image to an existing template in database 24. If an adequate match is found, the image is classified as belonging to that template. Otherwise, the image is held for later classification. For this purpose, the processor attempts to group the image with other unclassified images, in order to define a new template, as described below in detail with reference to FIGS. 3-5.

At a compression step 44, processor 22 compresses the image, preferably by dropping out the image template, as described above. The fill image remaining after dropout of the template may be further compressed, using image compression methods known in the art. In a store step 46, the fill image is stored in the database 24, along with an identification of the class to which the image belongs. For each class, a single copy of the corresponding template is held in database 24. Preferably, for efficient operation, servers 20 maintain a common repository of all the image classes and the corresponding template images in their respective databases 24. In this manner, the same templates may conveniently be reused for image compression and decompression by all the servers. Processor 22 typically carries out steps 42-46 (as well as the processing steps shown in the figures below) autonomously, without involvement of the user of workstation 26 and in a manner that is essentially transparent to the user. The user is involved only in inputting images, at step 40, while server 20 classifies, compresses and stores the images as a background process.

FIG. 2B is a flow chart that schematically illustrates a method for retrieving images, such as the image of document 32, from image database 24, in accordance with a preferred embodiment of the present invention. The method is typically initiated in response to a request from a user of one of workstations 26. In response to the request, at an initial step 48, server 20 retrieves the compressed image from the image database in its compressed form. If the image is stored at another one of the servers, the server receiving the user requests asks the server holding the compressed image to forward it over a communication link between the servers. Typically, only the fill image is forwarded, along with the class identification of the image, assuming the requesting server already has a copy of the appropriate template. (Otherwise, the template may be forwarded, as well.)

At a decompression step 50, server 20 decompresses and reconstructs the image, and serves the image to the requesting workstation 26. The decompressed image may be displayed on user interface 28. Alternatively, only portions of the image may be displayed, such as certain fields of the fill image. Further alternatively or additionally, automated processing, such as optical character recognition (OCR) may be applied to the fill image. The absence of template features from the fill image generally enhances the accuracy of OCR operations.

FIG. 3 is a flow chart that schematically illustrates a method for updating image database 24, in accordance with a preferred embodiment of the present invention. This method is used in conjunction with step 42 in classifying a set of images received by server 20, and in dealing with unclassified images. At an initial step 60, processor 22 accesses the first document image in the set for processing. At a test step 62, the processor determines whether this document image has been classified and compressed using domain-specific compression, at steps 42 and 44, as described above. Unclassified images are queued for further processing, at a queuing step 64. (The term “queuing” is used loosely here to refer to any and all methods that may be used for collecting, holding or marking a set of images or other data files in memory for later processing.) The process of steps 62 and 64 continues through all the images in the set up to a last image check step 66.

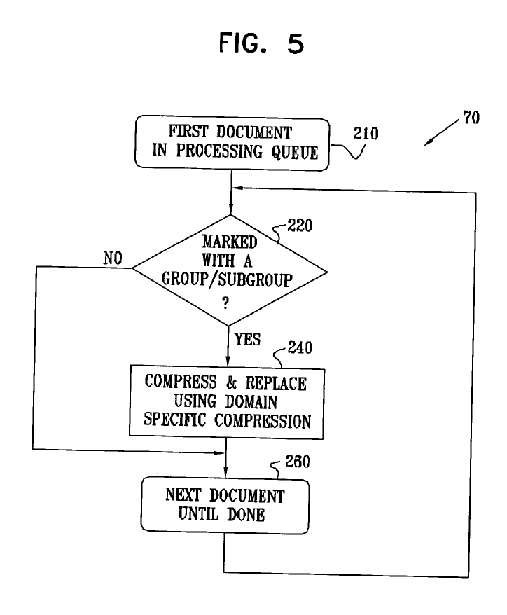

After queuing all the unclassified images, processor 22 attempts to divide these images into new classification groups, at a create groups step 68. Details of this step are described below with reference to FIG. 4. Processor 22 may be programmed to undertake this step at certain predetermined intervals or whenever the queue reaches a certain size. Alternatively, the classification process may run continuously as a background process in system 10, carried out by each of servers 20 individually or by two or more of the servers in collaboration. Any images in the queue that are not classified into one of the new groups simply remain in the queue, until the next cycle through step 68. For any new group that has been found at step 68, processor 22 extracts the corresponding template, and then drops the template out of the images in the group in order to compress the images, at a compression step 70. Details of this step are described below with reference to FIG. 5.

FIG. 4 is a flow chart that schematically illustrates details of create groups step 68, in accordance with a preferred embodiment of the present invention. This particular implementation is described here by way of example. Other methods for creating groups and subgroups of images and updating the data structures in database 24 will be apparent to those skilled in the art and are considered to be within the scope of the present invention. In an initial step 110, processor 22 selects the recognition basis to be used in classifying the images in the present queue. For example, if the images are of unprocessed form documents, the groups will be characterized by templates having a similar line structure, and therefore the recognition basis would be defined in terms of lines. Alternatively or additionally, the basis for classification may comprise characters or other shapes.

In a define groups step 120, processor 22 forms groups of images that are similar with respect to the current classification criteria. The above-mentioned U.S. patent application Ser. Nos. 09/566,058 and 09/777,792 describe methods that can be used for this purpose. The latter of these patent applications also describes methods for sub-dividing a group of similar images into subgroups of greater homogeneity. To the extent that such subgroups can be identified and created, the images in each subgroup will typically have a larger common portion (and thus a more extensive template) than can be defined for the group as a whole. For example, assuming system 10 is used to compress images of checks drawn on different banks, there will be large groups of checks that have the same template of lines. Such groups may be broken into smaller subgroups based on the bank names and branch information printed on the checks. Finally, if there are sufficient numbers of checks drawn on certain bank accounts, smaller subgroups may be defined based on the account name and/or number.

Thus, in an augment classification step 130, processor 22 augments its classification scheme based on factors that can be used to differentiate the images within a single group. In a define subgroups step 140, the processor uses the augmented scheme to group certain images into more homogenous subgroups. For each group or subgroup, processor 22 extracts a template, in a derive class information step 150. The method described in U.S. patent application Ser. No. 09/566,058 may be used for this purpose, for example. The template, and any relevant ancillary information regarding the group or subgroup to which it applies, is stored in database 24, at an update data structures step 160. As noted above, the classification information and template are preferably distributed among all the servers in system 10. In a mark images step 170, images in the processing queue that have now been classified are marked as such in the processing queue. These images are then compressed at step 70, as described above.

FIG. 5 is a flow chart that schematically illustrates details of compression step 70, in accordance with a preferred embodiment of the present invention. In an initial step 210, processor 22 selects the first document image in the processing queue for compression. Some or all of the images in the processing queue may have been marked at step 170 as belonging to a group or subgroup, or, equivalently, as being associated with a template. At a test step 220, each document image is tested as to whether it is so marked. If the document image is marked as part of a group or subgroup, then processor 22 uses the corresponding template to compress the image, at a compression step 240. As stated earlier, this process typically involves registering the template with the image, and then dropping the template out of the image, as described, for example, in the above-mentioned U.S. patents or in U.S. patent application Ser. No. 09/379,244. The processor iterates through all the images until it reaches the end of the queue, at a check for done step 260.

Server 20 may apply the classification methods described above not only to process unclassified images, but also to improve compression of images that have already been classified and compressed. The server may undertake this activity, for example, during off-hours, when the queue of unclassified images is short. In this case, instead of applying the methods of FIGS. 4 and 5 to the queue, processor 22 extracts and processes the images in an existing group from database 24. The processor then attempts to divide the extracted group into subgroups, as described above at steps 130 and 140. For this purpose, the processor may choose a group of images in database 24 that is particularly large, or that occupies a large volume of storage, relative to the size of the group. In these cases, there is a reasonable probability that the processor will be able to define subgroups, and improve the compression of the images by extracting a more extensive template for each subgroup. For example, the processor may be able to divide a stored group of checks from the same bank into subgroups belonging to particular customers, as noted above. In this manner, system 10 continually improves its utilization of available storage resources.

Although the preferred embodiments described herein are concerned mainly with processing of form documents, the principles of the present invention may similarly be applied in other image processing contexts in which groups of images share certain domain-specific content. For example, the present invention may be used in classify and compressing medical or aerial images, as well as different types of document images, such as credit card slips. The methods of the present invention may be applied not only to binary images, as are commonly used in document processing, but also, mutatis mutandis, to gray-scale and color images.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for storing images that are input to a storage system by one or more operators, the method comprising:
classifying a first portion of the images into a plurality of predefined groups, such that the images in each predefined group of the plurality are characterized by respective common information shared by all the images in the predefined group;
processing a second portion of the images, which were not classifiable into any of the predefined groups, so as to define a new group containing a subset of the second portion of the images, such that the images in the new group are characterized by new common information shared by all the images in the new group; and
compressing the images in each group among the predefined and new groups by extracting from each of the images the common information that characterizes the group.

2. The method according to claim 1, wherein the steps of classifying, processing and compressing are carried out autonomously by the storage system, substantially without involvement of the one or more operators.

3. The method according to claim 1, wherein the images comprise images of form documents.

4. The method according to claim 3, wherein extracting the common information comprises removing a template of the form documents from the images.

5. The method according to claim 1, and comprising processing at least one of the predefined and new groups so as to subdivide the at least one of the groups into sub-groups, each characterized by respective sub-group common information, wherein compressing the images comprises extracting the respective sub-group common information from the images in the sub-groups.

6. The method according to claim 5, and comprising storing the compressed images in a memory of the storage system, wherein processing the at least one of the predefined and new groups comprises recalling the compressed images in the at least one of the predefined and new groups from the memory in order to process the images, and wherein the images in the sub-group occupy a reduced volume of the memory after the respective subgroup common information is extracted from the images.

7. The method according to claim 1, wherein processing the second portion of the images comprises adding the new group to the plurality of predefined groups for use in classifying further images that are subsequently input to the storage system.

8. The method according to claim 1, wherein processing the second portion of the images comprises collecting the images that are not classifiable into any of the predefined groups, and processing the collected images on a scheduled basis.

9. The method according to claim 1, wherein processing the second portion of the images comprises collecting the images that are not classifiable into any of the predefined groups, and processing the collected images when a predetermined number of the images that are not classifiable have been collected.

10. The method according to claim 1, wherein the storage system comprises at least first and second servers at respective first an second locations, which are mutually remote, and wherein processing the second portion of the image comprises determining the new common information of the new group using the first server, and conveying the new common information to the second server, and comprising storing the new common information at the second location for use in at least one of compressing and decompressing further images at the second server.

11. Apparatus for storing images that are input by one or more operators, the apparatus comprising an image processor, which is arranged to classify a first portion of the images into a plurality of predefined groups, such that the images in each predefined group of the plurality are characterized by respective common information shared by all the images in the predefined group, to process a second portion of the images, which were not classifiable into any of the predefined groups, so as to define a new group containing a subset of the second portion of the images, such that the images in the new group are characterized by new common information shared by all the images in the new group, and to compress the images in each group among the predefined and new groups by extracting from each of the images the common information that characterizes the group.

12. The apparatus according to claim 11, wherein the image processor is arranged to classify, process and compress the images autonomously, substantially without involvement of the one or more operators.

13. The apparatus according to claim 11, wherein the images comprise images of form documents.

14. The apparatus according to claim 13, wherein the common information extracted by the image processor comprises a template of the form documents.

15. The apparatus according to claim 11, wherein the image processor is arranged to process at least one of the predefined and new groups so as to subdivide the at least one of the groups into sub-groups, each characterized by respective sub-group common information, and to compress the images by extracting the respective sub-group common information from the images in the subgroups.

16. The apparatus according to claim 15, which further comprises a memory, which is arranged to store the compressed images, wherein the image processor is arranged to recall the compressed images in the at least one of the predefined and new groups from the memory in order to process the images, and wherein the images in the sub-group occupy a reduced volume of the memory after the respective sub-group common information is extracted from the images.

17. The apparatus according to claim 11, wherein the image processor is arranged to add the new group to the plurality of predefined groups for use in classifying further images that are subsequently input to the storage system.

18. The apparatus according to claim 11, wherein the image processor is arranged to collect the images that are not classifiable into any of the predefined groups, and to process the collected images on a scheduled basis.

19. The apparatus according to claim 11, wherein the image processor is arranged to collect the images that are not classifiable into any of the predefined groups in a queue, and to process the collected images when a predetermined number of the images that are not classifiable have been collected.

20. The apparatus according to claim 11, wherein the image processor is one of at least first and second image processors comprised in the apparatus at respective first an second locations, which are mutually remote and are connected by a communication link, and wherein the first image processor is arranged to convey the new common information to the second image processor over the communication link, and the second image processor is arranged to store the new common information at the second location for use in at least one of compressing and decompressing further images at the second location.

21. A computer software product for storing images that are input to a storage system by one or more operators, the product comprising a computer-readable medium in which program instructions are stored, which instructions, when read by a computer, cause the computer to classify a first portion of the images into a plurality of predefined groups, such that the images in each predefined group of the plurality are characterized by respective common information shared by all the images in the predefined group, to process a second portion of the images, which were not classifiable into any of the predefined groups, so as to define a new group containing a subset of the second portion of the images, such that the images in the new group are characterized by new common information shared by all the images in the new group, and to compress the images in each group among the predefined and new groups by extracting from each of the images the common information that characterizes the group.

22. The product according to claim 21, wherein the instructions cause the computer to classify, process and compress the images autonomously, substantially without involvement of the one or more operators.

23. The product according to claim 21, wherein the images comprise images of form documents.

24. The product according to claim 23, wherein the common information extracted by the computer comprises a template of the form documents.

25. The product according to claim 21, wherein the instructions cause the computer to process at least one of the predefined and new groups so as to subdivide the at least one of the groups into sub-groups, each characterized by respective sub-group common information, and to compress the images by extracting the respective sub-group common information from the images in the subgroups.

26. The product according to claim 25, wherein the instructions cause the computer to store the compressed images in a memory, and further cause the computer to recall the compressed images in the at least one of the predefined and new groups from the memory in order to process the images, and wherein the images in the subgroup occupy a reduced volume of the memory after the respective sub-group common information is extracted from the images.

27. The product according to claim 21, wherein the instructions cause the computer to add the new group to the plurality of predefined groups for use in classifying further images that are subsequently input to the storage system.

28. The product according to claim 21, wherein the instructions cause the computer to collect the images that are not classifiable into any of the predefined groups in a queue, and to process the collected images on a scheduled basis.

29. The product according to claim 21, wherein the instructions cause the computer to collect the images that are not classifiable into any of the predefined groups, and to process the collected images when a predetermined number of the images that are not classifiable have been collected.

30. The product according to claim 21, wherein the computer is one of at least first and second computers comprised in the storage system at respective first an second locations, which are mutually remote and are connected by a communication link, and wherein the instructions cause the first computer to convey the new common information to the second computer over the communication link, and cause the second computer to store the new common information at the second location for use in at least one of compressing and decompressing further images at the second location.
